(19) United States
(12) Patent Application Publication
(10) Pub. No.: US 2010/0071424 A1
(43) Pub. Date: Mar. 25, 2010

(54) ELECTRIC LOCK FOR OPEN-CLOSE BODY

(75) Inventor: Hiroshi TSURUTA, Aichi (JP)

Correspondence Address: J. Rodman Steele;Novak Druce & Quigg LLP, 525 Okeechobee Blvd, Suite 1500, West Palm Beach, FL, 33401, US

(73) Assignee: KABUSHIKI KAISHA TOKAI RIKA DENKI SEISAKUSHO, Niwa-gun (JP)

(21) Appl. No.: 12/563,631

(22) Filed: Sep. 21, 2009

(30) Foreign Application Priority Data
Sep. 24, 2008 (JP) JP2008/244633

(51) Int. Cl. E05B 47/00; E05B 65/06; E05B 53/00

(52) U.S. Cl. 70/91; 70/263; 70/391

(57) ABSTRACT

An electric lock for a glove box lid closed when a lock member is engaged with a fastening portion and allowed to open when the lock member is disengaged from the fastening portion. The electric lock includes an operation unit operated by a vehicle occupant when opening the glove box lid. A verification unit performs verification of the vehicle occupant. A lock release member pushes the lock member and separates the lock member from the fastening portion when the operation unit is operated in a state in which the verification is established. A disconnection unit integrally connects the operation unit and lock release member when verification is established and disconnects the operation unit and lock release member when not established. When verification is not established, a control unit prohibits the disconnection unit from integrally connecting the operation unit and lock release member to disable opening of the glove box lid.

### CROSS-REFERENCE TO RELATED APPLICATIONS

This application is based upon and claims the benefit of priority from prior Japanese Patent Application No. 2008-244633, filed on Sep. 24, 2008, the entire contents of which are incorporated herein by reference.

### BACKGROUND OF THE INVENTION

The present invention relates to an electric lock for electrically switching an open/close body between a locked state and an unlocked state.

A glove box is arranged in front of a passenger's seat in a vehicle. The glove box includes a mechanical latch device. The mechanical latch device includes a lid latch (fastener) and a glove box striker. The lid latch is engaged with the glove box striker when the glove box lid is closed. To open the glove box lid, the vehicle occupant operates a handle of the glove box lid. This disengages the lid latch from the glove box striker and allows the glove box lid to open. When the vehicle occupant moves the glove box lid to a closed position in order to close the glove box lid, the lid latch becomes engaged with the glove box striker at the closed position. This keeps the glove box lid closed.

Patent document 1 discloses an example of a mechanical latch device 81, which is shown in FIG. 10. The mechanical latch device 81 includes a lock bar 84, which functions as a latch (fastener). The lock bar 84 is arranged in a glove box lid 83 of a glove box 82. The lock bar 84 may be moved back and forth in a widthwise direction of the glove box lid 83. FIG. 10 shows the lock bar 84 at a projected position. FIG. 11 shows the lock bar 84 at a pressed position. An urging member (not shown) urges the lock bar 84 towards the projected position of FIG. 10. A frame 85 of the glove box 82 includes an operation button 86 that is pushed when opening the glove box lid 83, i.e., when releasing the mechanical latch device 81. The frame 85 also includes a pushing pin 87 for pushing the lock bar 84 out towards the pressed position when the operation button 86 is pushed.

The vehicle occupant pushes the operation button 86 when opening the glove box lid 83. The pushed operation button 86 moves the pushing pin 87 towards the glove box lid 83. This pushes the lock bar 84 to the pressed position (see FIG. 11) and moves the lock bar 84 out of a fastening hole 88, which extends through a side wall of the frame 85. As a result, the mechanical latch device 81 is switched from a fastened state to a released state in which opening of the glove box lid 83 is allowed.

To close the glove box lid 83, the vehicle occupant pivots the glove box lid 83 towards the closed position. The lock bar 84 becomes engaged with the fastening hole 88 in the final pivoting stage. This holds the glove box lid 83 at the closed position.

A glove box lock mechanism restricts opening and closing of the glove box lid 83. The conventional glove box lock mechanism disables the pushing of the operation button 86 so as to restrict opening and closing of the glove box lid 83. A mechanical key, which is used with a key cylinder that serves to verify the key, is often employed as the glove box lock mechanism since it is inexpensive and has a simple structure.

The operation of the mechanical key verification type glove box lock mechanism in the prior art will now be described.

When unlocking the glove box 82, the vehicle occupant inserts a mechanical key into a key cylinder of the glove box lock mechanism and rotates a rotor in the key cylinder from a lock position to an unlock position. The rotation of the rotor separates a fastening piece, which restricts the pushing of the operation button 86, from the operation button 86. This enables pushing of the operation button 86 and allows the glove box lid 83 to open.

When locking the glove box 82, the vehicle occupant inserts the mechanical key into the key cylinder of the glove box lock mechanism and rotates the rotor in a direction opposite to the direction the rotor was rotated when unlocking the glove box 82. This switches the rotor from the unlock position to the lock position. The rotation of the rotor projects the fastening piece toward the operation button 86. This disables pushing of the operation button 86 and locks the glove box 82.

[Patent document 1] Japanese Laid-Open Patent Publication No. 2006-327332

### SUMMARY OF THE INVENTION

However, the glove box lock mechanism of the prior art has a relatively low level of breakage resistance. For example, a third person such as a thief may push the operation button 86 in a locked state with force exceeding a tolerable value. This would break the lock mechanism, in which case, the glove box 82 would be in a freely openable state.

It is an object of the present invention to provide an electric lock for an open/close body that resists unauthorized unlocking.

One aspect of the present invention is an electric lock for an open/close body. The open/close body is closed when a lock member is engaged with a fastening portion and allowed to open when the lock member is disengaged from the fastening portion. The electric lock includes an operation unit operated by an operation personnel when opening the open/close body. A verification unit performs individual verification of the operation personnel. A lock release member pushes the lock member and separates the lock member from the fastening portion when the operation unit is operated in a state in which the individual verification is established. A disconnection unit operates in accordance with an electrical signal. The disconnection unit arranges the operation unit and the lock release member as integrally connected parts in a state in which the individual verification is established. The disconnection unit arranges the operation unit and the lock release member as disconnected parts in a state in which the individual verification is not established. A control unit receives an individual verification result from the verification unit and drives the disconnection unit in accordance with the individual verification result. Unless the individual verification is established, the control unit prohibits the disconnection unit from switching the operation unit and the lock release member to the integrally connected parts and disables opening of the open/close body.

In this structure, the disconnection unit connects the operation unit and the lock release member so that the operation unit and the lock release member operate as integrally connected parts only when the verification unit confirms that the individual verification is established. Thus, the operation force applied to the operation unit from the outside (e.g., an operation personnel such as vehicle occupant) when the individual verification is established is transmitted to the lock member through the lock release member. This switches the open/close body to an unlocked state. The lock member is disengaged from the fastening portion by the operation force when the operation unit is operated in a state in which the individual verification is established to allow the open/close body to open.

When the verification unit confirms that the individual verification is not established, the disconnection unit mechanically separates the operation unit and the lock release member so that the operation unit and the lock release member become disconnected parts, which are disconnected from each other. Thus, the operation force externally applied to the operation unit when the individual verification is not established is not transmitted to the lock release member. In this case, the lock release member does not move and the lock member also does not move even if the operation force is applied to the operation unit. This maintains the open/close body in a locked state. Therefore, as long as the individual verification is not established, the operation of the operation unit is invalid (state referred to as “operation of the operation unit being a null operation”) and opening of the open/close body is not allowed.

When performing unauthorized unlocking, the fastened state of the lock member and the fastening portion cannot be broken even when applying excessive force to the operation unit as long as the individual verification is not established. Thus, the present invention prevents unauthorized unlocking of the open/close body.

The electric lock of one aspect of the present invention further includes a detector which detects operation of the operation unit. The control unit activates the disconnection unit when the detector detects operation of the operation unit in a state in which the individual verification is established. The disconnection unit, when activated by the control unit, arranges the operation unit and the lock release member as the integrally connected parts when activated by the control unit so as to allow the open/close body to open.

In this structure, power is supplied to the disconnection unit at a timing in which the detector detects the operation of the operation unit. The power supplied to the disconnection unit may be stopped when the operation unit is not operated. This reduces power consumption of the electric lock.

In the electric lock of one aspect of the present invention, the verification unit includes an electronic key authentication unit which performs key authentication as the individual verification by authenticating a key code transmitted through wireless communication from an electronic key with an ID code of the verification unit.

In this structure, the establishment of key authentication is one requirement for opening the open/close body. A person needing to open the open/close body must be in possession of an authentic electronic key. A proper user would normally carry the authentic electronic key. Thus, a third person who does not have the authentic electronic key would not be able to open the open/close body in an unauthorized manner. This improves security of the open/close body.

In the electric lock of one aspect of the present invention, the disconnection unit includes a cooperative member which moves in cooperation with the operation unit. The cooperative member is mechanically separated from the lock release member. A switching member is arranged between the cooperative member and the lock release member. The switching member operates in accordance with the control unit and switches the operation unit and the lock release member to either the integrally connected parts or the disconnected parts.

In this structure, the operation unit does not require a mechanism (disconnection unit) for integrally connecting and disconnecting the operation unit and the lock release member. This simplifies the structure of the operation unit.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing the structure of a preferred embodiment of an electronic key system according to the present invention;

FIG. 2A is a perspective view showing a passenger compartment near a closed glove box;

FIG. 2B is a perspective view showing an open glove box;

FIG. 3 is a cross-sectional view showing the glove box in a locked state;

FIG. 4 is a cross-sectional view showing the glove box in an unlocked state;

FIG. 5 is a cross-sectional view taken along line II-II in FIG. 7;

FIG. 6 is a diagram showing the position of a button operation detection switch;

FIG. 7 is a cross-sectional view showing a disconnection unit in a state in which the glove box lid is closed;

FIG. 8 is a cross-sectional view showing the disconnection unit in a state enabling opening of the glove box lid;

FIG. 9 is a cross-sectional view of the disconnection unit in a state disabling opening the glove box lid; and

FIGS. 10 and 11 are cross-sectional views of a mechanical latch device in the prior art.

### DETAILED DESCRIPTION OF THE PREFERRED EMBODIMENTS

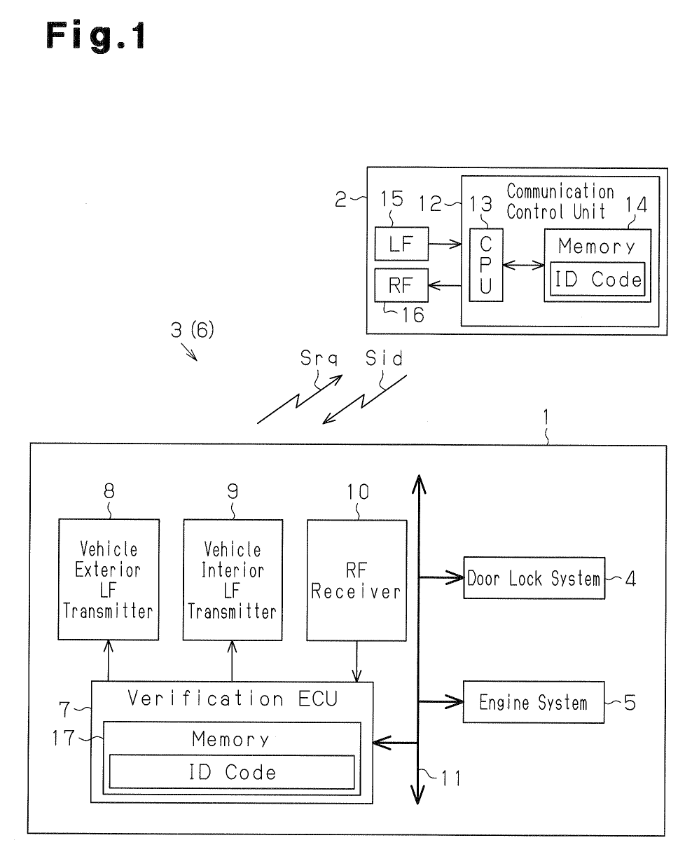

A preferred embodiment of an electric lock for a lid according to the present invention will now be discussed with reference to FIGS. 1 to 9.

As shown in FIG. 1, a vehicle 1 includes an electronic key system 3, a door lock system 4, and an engine system 5. The electronic key system 3 communicates with an electronic key 2, which serves as a vehicle key, to perform key verification. The door lock system 4 locks and unlocks vehicle doors (seat doors and luggage door). The engine system 5 manages the power supply state (power supply position) of the vehicle 1 and the starting and stopping of the engine. The electronic key 2 performs a narrowband wireless communication with the vehicle 1 to transmit an ID code (also referred to as key code) of the electronic key 2 to the vehicle 1. The electronic key system 3 serves as a verification unit. An authentication electronic control unit (ECU) 7 serves as an electronic key authentication unit.

One example of the electronic key system 3 is a key-operation-free system 6 in which a user does not have to perform a key operation to transmit the ID code of the electronic key 2. The key-operation-free system 6 includes a smart entry system in which a key operation is not necessary when locking and unlocking the door. In such a smart entry system, the authentication ECU 7, which is arranged in the vehicle 1, performs key authentication (ID authentication) with the electronic key 2. The authentication ECU 7 is connected to a vehicle exterior LF transmitter 8, which transmits signals in an LF band (low frequency of about 130 kHz) to the exterior of the vehicle, a vehicle interior LF transmitter 9, which transmits signals in the same LF band to the interior of the vehicle, and an RF receiver 10, which receives signals in an RF band (radio frequency of about 312 MHz). The authentication ECU 7 is connected to the door lock system 4 and the engine system 5 by of an in-vehicle local area network (LAN) 11.

A communication control unit 12 of the electronic key 2 controls various types of operations of the electronic key 2. The communication control unit 12 includes a central processing unit (CPU) 13 and a memory 14. The ID code of the electronic key 2 is registered in the memory 14. The communication control unit 12 is connected to an LF receiver 15, which receives wireless signals in the LF band, and an RF transmitter 16, which transmits wireless signals in the RF band. The communication control unit 12 monitors the type of wireless signal received by the LF receiver 15 and manages signal transmissions from the RF transmitter 16.

While the vehicle 1 is in a parked state, the authentication ECU 7 intermittently transmits a request signal Srq in the LF band from the vehicle exterior LF transmitter 8, forms a vehicle exterior communication area of the request signal Srq around the vehicle, and attempts to establish narrowband wireless communication (hereinafter referred to as smart communication). When the electronic key 2 enters the vehicle exterior communication area and receives the request signal Srq. In response to the request signal Srq, the electronic key 2 generates an ID signal Sid (RF band signal) including the ID code of the electronic key 2 registered in its memory 14 and returns the ID signal Sid. The RE receiver 10 then receives the ID signal Sid thereby establishing the smart communication. Then, the authentication ECU 7 performs ID authentication (also referred to as smart authentication or vehicle exterior authentication) to authenticate the ID code of the electronic key 2 with the ID code registered in its memory 17. After confirming that the vehicle exterior authentication has been established, the authentication ECU 7 allows for or performs locking or unlocking of the doors with the door lock system 4.

The key-operation-free system 6 includes a one-push engine start system allowing for the engine (not shown) to be started or stopped just by performing a switch operation. This eliminates the need for an actual vehicle key operation when starting or stopping the engine. In such a one-push engine start system, when a courtesy switch (not shown) indicates that the driver has entered the vehicle, the authentication ECU 7 transmits a request signal Srq from the vehicle interior LF transmitter 9 instead of the vehicle exterior LF transmitter 8 so as to form a vehicle interior communication area in the entire passenger compartment of the vehicle. When the RF receiver 10 receives the ID signal Sid, which is returned in response from the electronic key 2 that is located in the vehicle interior communication area, the authentication ECU 7 authenticates the ID code of the electronic key 2 with the ID code registered therein. Such ID authentication is also referred to as smart authentication or in-vehicle authentication. After confirming that the in-vehicle authentication has been established, the authentication ECU 7 allows for the power supply state to be switched by the engine system 5.

The one-push engine start system starts the engine when the engine is in a stopped state, the brake pedal is in a depressed state, and the engine switch (not shown), which is of a momentary push type, is in the pushed state. The one-push engine start system stops the engine when the engine is running, the gearshift lever is located at a parking position (P range), and the engine switch is in a pushed state. In a state in which the engine is stopped, if the engine switch is pushed without the brake pedal being depressed, the one-push engine start system repeatedly switches the power supply state in the order of power OFF→ACC ON→IG ON whenever the engine switch is pushed.

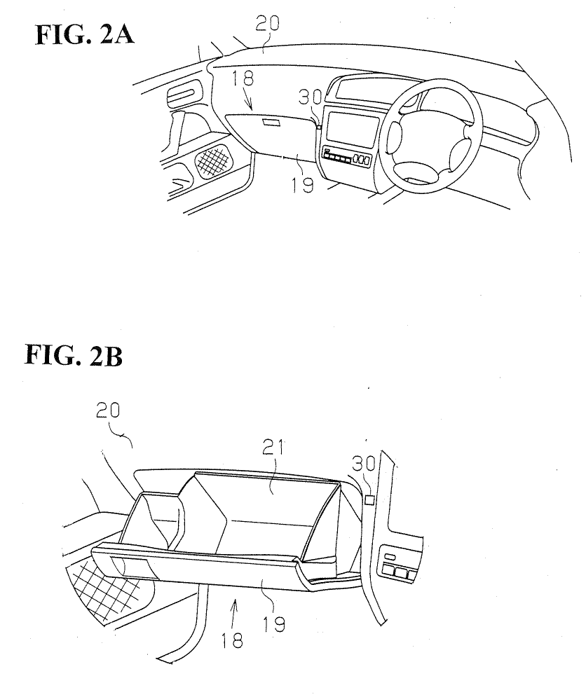

As shown in FIG. 2A, a glove box 18 is arranged in front of the passenger seat in the passenger compartment of the vehicle 1. The glove box 18 has a door, or a glove box lid 19, attached to a dashboard 20 in an openable manner. In the illustrated example, the lower end of the glove box lid 19 is coupled to the dashboard 20 by a hinge mechanism (not shown). When the glove box lid 19 opens, an accommodating compartment 21 of the glove box 18 opens upward. The glove box lid 19 serves as an open/close body.

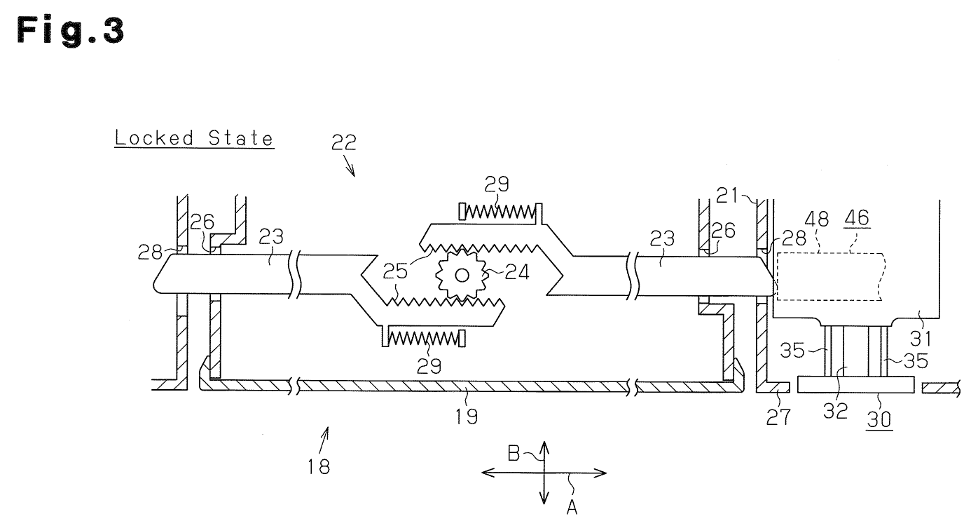

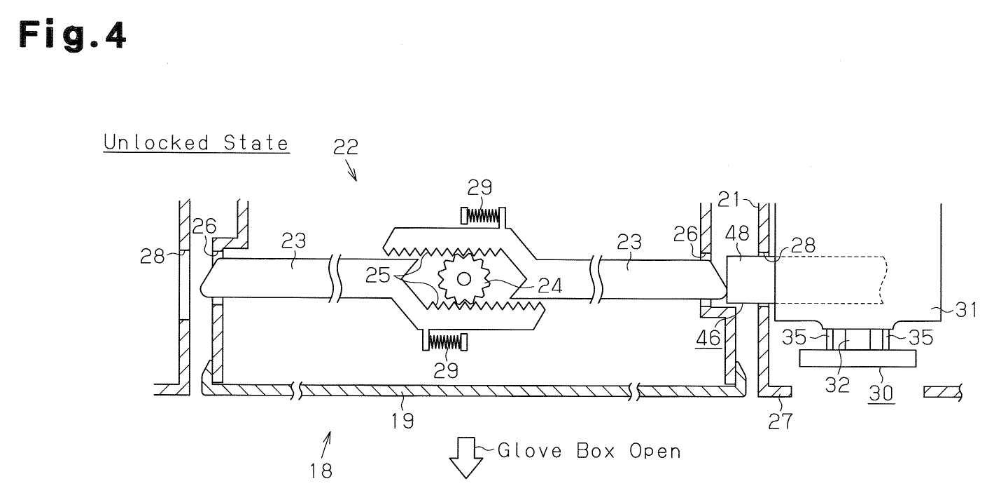

With reference to FIGS. 3 and 4, a door latch device 22 will be described. When the glove box lid 19 is closed, the door latch device 22 maintains the glove box lid 19 in a closed state. When the proper procedures are carried out, the door latch device 22 releases the glove box lid 19 from the closed state and allows for the glove box lid 19 to open. The door latch device 22 includes a latch, or two lock bars 23, which are attached to the glove box lid 19 in the glove box 18 and supported so that they may be moved back and forth in a widthwise direction (direction of arrow A in FIG. 3). A gear 24 having a rotation shaft that intersects the widthwise direction A of the glove box lid 19 is arranged at a central portion in the glove box lid 19. The gear 24 is mated with a gear portion 25 of each lock bar 23. The two lock bars 23 are connected to each other by the gear 24. When one of the lock bars 23 is pushed inward, the other lock bar 23 is also pushed inward (FIG. 4). When one of the lock bars 23 is projected outward, the other lock bar 23 also projects outward (FIG. 3). The lock bars 23 each have a distal end that projects out of the glove box lid 19 through a through hole 26 formed in the corresponding side wall of the glove box lid 19. The lock bars 23 each serve as a lock member.

Each lock bar 23 is engaged with a fastening hole 28 formed in a frame 27 of the dashboard 20. Each fastening hole 28 is formed to face the corresponding lock bar 23 when the glove box lid 19 is closed. Each lock bar 23 is urged by a urging member 29 so as to project out of the corresponding through hole 26. The urging member 29 has one end coupled to the lock bar 23 and another end coupled to the glove box lid 19. The urging member 29 may be a coil spring. The fastening hole 28 serves as a fastening portion.

The urging force of the urging member 29 maintains the lock bar 23 in a state engaged with the fastening hole 28. This holds the glove box lid 19 at the closed position in a state locked by the lock bar 23 (FIG. 3). When a pushing force countering the urging force of the urging member 29 is applied to the lock bar 23, the lock bar 23 moves out of the fastening hole 28. This releases the glove box lid 19 from the state locked by the lock bar 23. The weight of the glove box lid 19 automatically moves the glove box lid 19 downward to the state of FIG. 2B.

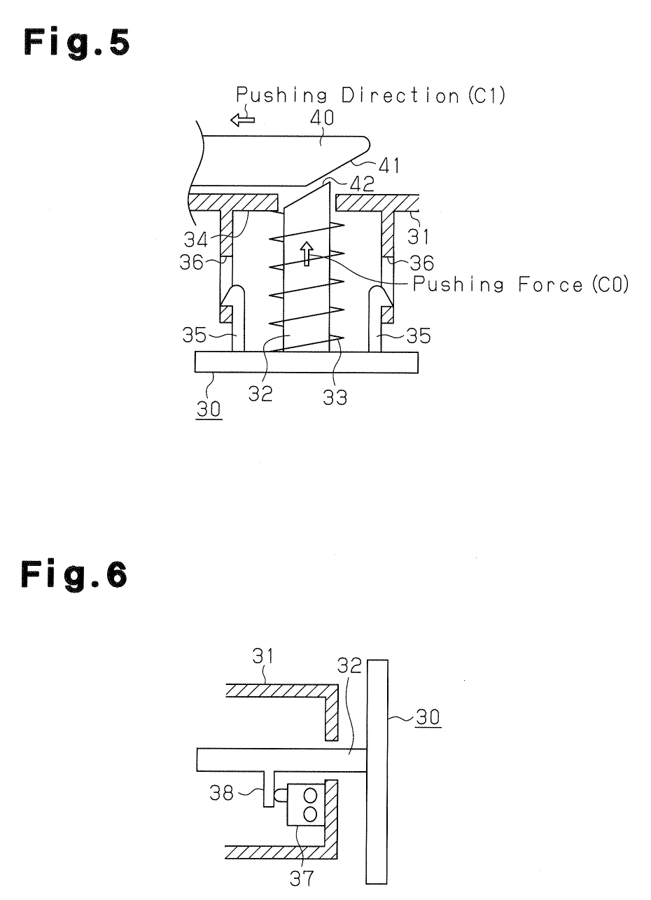

As shown in FIG. 2, an operation button 30 for opening the glove box lid 19 is arranged on the frame 27 (dashboard 20) near the glove box lid 19. The operation button 30 is of a momentary push type. The operation button 30 is attached to a case 31 arranged in the frame 27. The operation button 30 may be moved back and forth so that it may be pushed towards the front of the vehicle 1 and moved towards the rear of the vehicle 1 to return to its original position. The movement direction (arrow B of FIG. 3) of the operation button 30 is orthogonal to the movement direction (arrow A of FIG. 3) of the lock bars 23. As shown in FIG. 5, a shaft 32 extends from the operation button 30. The shaft 32 supports an urging member 33, which pushes back (returns) the pushed operation button 30 to an initial position. The urging member 33 has one end coupled to the rear surface of the operation button 30 and another end coupled to a catch 34 of the case 31. The urging member 33 may be a coil spring. The operation button 30 serves as an operation unit.

As shown in FIG. 5, two fastening hooks 35 extend from the rear surface of the operation button 30 on opposite sides of the shaft 32. Two elongated holes 36 are formed in the case 31 extending in the longitudinal direction (arrow B of FIG. 3) of the vehicle 1. The operation button 30 is attached to the case 31 by engaging each fastening hook 35 with the corresponding elongated hole 36. The urging member 33 urges the operation button 30 until the operation button 30 stops at the initial position as the fastening hook 35 comes into contact with one end of the elongated hole 36. In this manner, the operation button 30 is allowed to move back and forth without falling out of the reciprocating movement of the case 31.

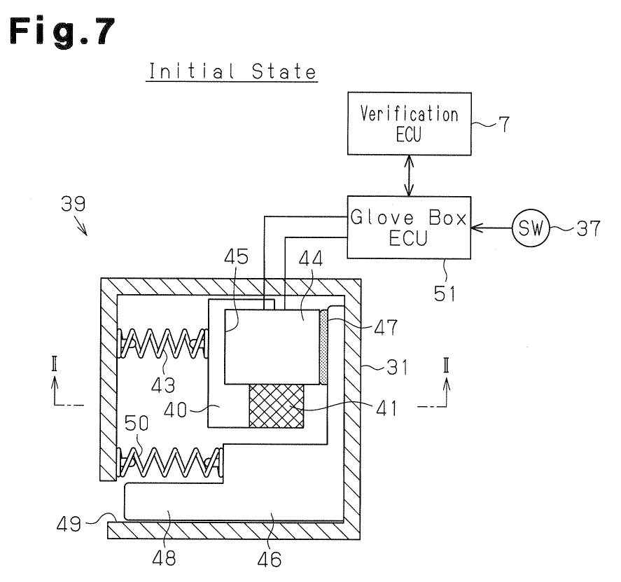

As shown in FIG. 6, a button operation detection switch 37 is arranged in the case 31. The button operation detection switch 37 detects whether or not the operation button 30 has been operated. Specifically, the button operation detection switch 37 detects when the pushing of the operation button 30 starts. The button operation detection switch 37 may be a microswitch. When the operation button 30 is not operated, contact of the operation button 30 with a tab 38 extending from the shaft 32 activates the button operation detection switch 37. When the operation button 30 is operated, the button operation detection switch 37 is separated from the tab 38. In this manner, the button operation detection switch 37 detects the operation of the operation button 30. The button operation detection switch 37 provides a detection signal to a glove box ECU 51, which is shown in FIG. 7. The button operation detection switch 37 serves as a detector.

A mechanism 39 for switching the operation button 30 between a state in which it is allowed to open the glove box lid 19 and a state in which it is not allowed to open the glove box lid 19 will now be described with reference to FIGS. 7 to 9. The mechanism 39 may be arranged in the case 31. The mechanism 39 includes an operation bar 40 that functions as an intermediate component for transmitting the operation force of the operation button 30 to the lock bar 23. The operation bar 40 is arranged in the case 31 and may be moved back and forth in the movement direction of the lock bar 23. The operation bar 40 includes a bar slope 41 formed at a position facing toward the shaft 32 of the operation button 30. A button slope 42 (see FIG. 5) that cooperates with the bar slope 41 is formed at the distal end of the shaft 32 of the operation button 30. When the operation button 30 is pushed, the button slope 42 presses and moves the bar slope 41. Therefore, the bar slope 41 and the button slope 42 convert the pushing force (arrow C0 of FIG. 5) of the operation button 30 into force in the pushing direction of the operation bar 40 (arrow C1 of FIG. 5). The mechanism 39 serves as a disconnection unit.

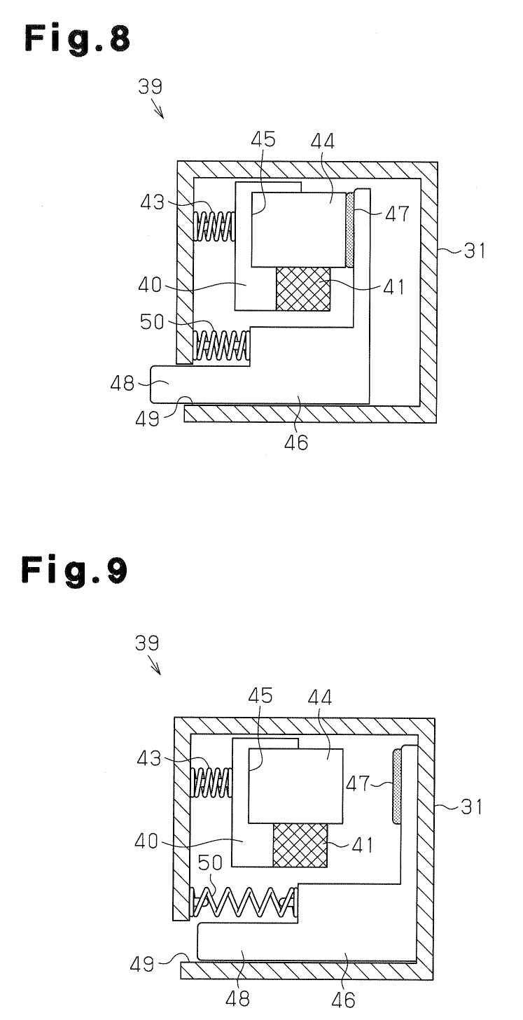

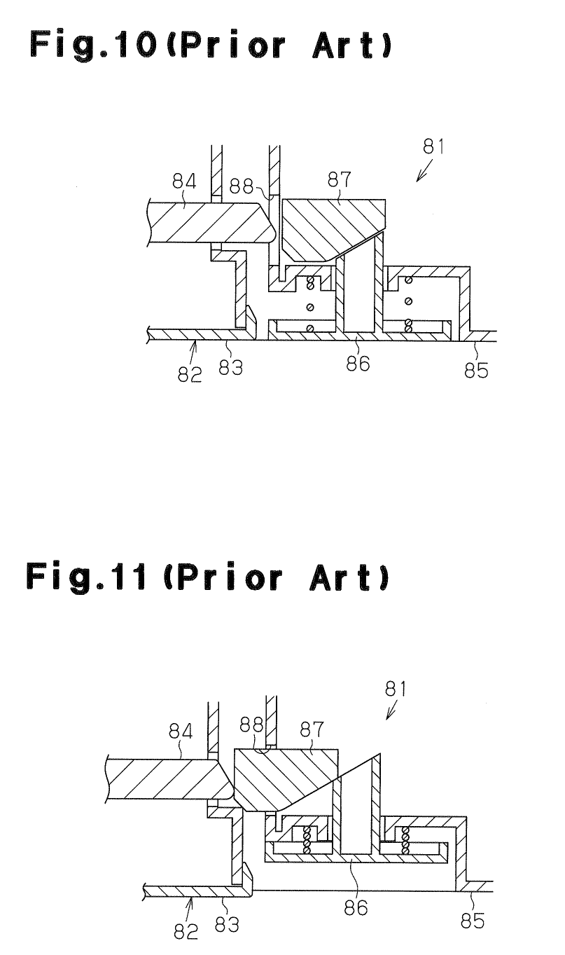

As shown in FIG. 7, an urging member 43 for urging the operation bar 40 in the rightward direction (retraction direction) of FIG. 7 is arranged between the operation bar 40 and an inner surface of the case 31. The urging member 43 may be a coil spring. When the operation button 30 is pushed, the operation bar 40 moves from the initial position to a pressed position (FIGS. 8 and 9) against the urging force of the urging member 43. When the pushed operation button 30 is released (e.g., when an operation personnel such as vehicle occupant releases his or her hand from the operation button 30), the urging force of the urging member 43 returns the operation bar 40 to the initial position (FIG. 7). The operation bar 40 and the urging member 43 form a cooperative member.

The operation bar 40 includes a solenoid 44. The solenoid 44 functions as an actuator of the mechanism 39. The solenoid 44 is received in a recess 45 formed in the operation bar 40 so as to move integrally with the operation bar 40. The solenoid 44 moves with the operation bar 40 to the pressed position (FIGS. 8 and 9) together when the operation button 30 is pushed. When the pushed operation bar 40 is released, by the urging force of the urging member 43 returns the solenoid 44 to the initial position (FIG. 7) with the operation bar 40. The solenoid 44 functions as a holding solenoid that acts as an electromagnet when supplied with power.

A lock release bar 46 is arranged in the case 31. The lock release bar 46 may be moved back and forth in the movement direction of the lock bars 23. The lock release bar 46 separates the lock bars 23 from the fastening holes 28 to release the door latch device 22. The lock release bar 46 has a metal plate 47 facing toward the solenoid 44. When the solenoid 44 is activated, the solenoid 44 magnetically attracts the plate 47, and the operation bar 40 and the lock release bar 46 become integrally connected parts, namely, a single mechanical part. If the operation button 30 is pushed in this state, the operation bar 40 and the lock release bar 46 move integrally to the pressed position, as shown in the state of FIG. 8. This causes contact of the lock release bar 46 with the lock bar 23 and separates the lock bar 23 from the fastening hole 28. In this state, the glove box lid 19 is allowed to open. The “integrally connected parts” are formed by a plurality of parts connected or joined with one another so to move as a single mechanical part. “Disconnected parts” are formed by a plurality of disconnected parts that do not move as a single mechanical part. The solenoid 44 and the plate 47 form a switching member. The lock release bar 46 serves as a lock release member.

When the solenoid 44 is not activated, the solenoid 44 does not magnetically attract the plate 47. Thus, the operation bar 40 and the lock release bar 46 are separated component parts or individual parts that are not mechanically connected to one another. If the operation button 30 is pushed in this state, the operation bar 40 moves but the lock release bar 46 does not move. Thus, the lock release bar 46 does not contact and press the lock bar 23, as shown in the state of FIG. 9. Accordingly, in a state in which the solenoid 44 is not activated, the lock bar 23 cannot be disengaged from the fastening hole 28 even if the operation button 30 is pushed, and the pushing of the operation button 30 results in a null operation. This maintains the glove box 18 in the locked state.

The lock release bar 46 includes a pushing portion 48 for pressing the lock bar 23. When the operation bar 40 moves as the operation button 30 is pushed, the pushing portion 48 projects out of a through hole 49 extending through a side wall of the case 31 and comes into contact with the lock bar 23. The pushing portion 48 is accommodated in the case 31 when the operation button 30 is not pushed and when the pushing of the operation button 30 is a null operation.

An urging member 50 is arranged between the lock release bar 46 and the inner surface of the case 31 to urge the lock release bar 46 in the retraction direction. The urging member 50 may be a coil spring (helical spring). The lock release bar 46 moves with the operation bar 40 to the pressed position (FIGS. 8 and 9) against the urging force of the urging member 50 when the solenoid 44 is activated. When the pushed operation button 30 is released, the urging force of the urging member 50 returns the lock release bar 46 to the initial position (FIG. 7). The operation bar 40 and the urging member 43 form a cooperative member.

Referring to FIG. 7, the vehicle 1 includes the glove box ECU 51, which serves as a control unit for managing the locking and unlocking of the glove box 18. The glove box ECU 51 includes various types of devices such as a CPU and a memory. The glove box ECU 51 is connected to the authentication ECU 7 by the in-vehicle LAN 11 and connected to the button operation detection switch 37 and the solenoid 44 by various electrical wires. The glove box ECU 51 serves as a control unit.

The glove box ECU 51 controls the locking and the unlocking of the glove box 18 based on the result of the key authentication performed between the vehicle 1 and the electronic key 2. Specifically, when the key authentication of the vehicle 1 and the electronic key 2 is established, the glove box ECU 51 activates the solenoid 44 so that the operation bar 40 and the lock release bar 46 become integrally connected parts. This allows the glove box 18 to be unlocked. If the key authentication is not established, the glove box ECU 51 does not activate the solenoid 44 and the operation bar 40 and lock release bar 46 become disconnected parts. In this case, the glove box 18 is maintained in the locked state.

The glove box ECU 51 determines the activation timing of the solenoid 44 based on the switch signal from the button operation detection switch 37. The glove box ECU 51 activates the solenoid 44 upon receipt of an operation detection signal from the button operation detection switch 37 indicating that the operation button 30 has been pushed under a state in which the in-vehicle authentication is established. This allows for the glove box 18 to open. Unless the in-vehicle authentication is established, the glove box ECU 51 does not activate the solenoid 44 even when receiving the operation detection signal from the operation button 30. This maintains the glove box lid 19 in the closed state.

The operation for opening and closing the glove box 18 with the glove box lid 19 will now be discussed.

First, the user holding the authentic electronic key 2 (master key) enters the vehicle. The authentication ECU 7 executes the in-vehicle authentication with the electronic key 2. When determining that the in-vehicle authentication is established, the authentication ECU 7 allows the glove box ECU 51 to activate the solenoid 44. When the authentication ECU 7 allows for activation of the solenoid 44, the glove box ECU 51 sets the glove box 18 in an unlocked state.

To open the glove box 18, the vehicle occupant pushes the operation button 30. The button operation detection switch 37 detects when the pushing of the operation button 30 starts. In response to such detection, the glove box ECU 51 checks the authentication ECU 7 for the result of the in-vehicle authentication. Since the in-vehicle authentication is established and the glove box 18 is set to the unlocked state, the authentication ECU 7 provides an in-vehicle authentication establishment signal to the glove box ECU 51 through the in-vehicle LAN 11.

The glove box ECU 51 activates the solenoid 44 in response to the in-vehicle authentication establishment signal from the authentication ECU 7. When activated, the solenoid 44 functions as an electromagnet and generates a magnetic force. The operation bar 40 and the lock release bar 46 become integrally connected parts due to the magnetic attraction force between the solenoid 44 and the plate 47. When the operation button 30 is further pushed and the operation bar 40 further moves in the pushing direction, the operation bar 40 and the lock release bar 46 move integrally in the pushing direction, as shown in FIG. 8. The lock release bar 46 pushes in the lock bar 23 and separates the lock bar 23 from the fastening hole 28. In this manner, the glove box lid 19 is allowed to open.

A situation in which a vehicle occupant enters the vehicle but cannot establish in-vehicle authentication, such when the vehicle occupant forgets the electronic key 2, will now be described. When determined that the in-vehicle authentication is not established, the authentication ECU 7 does not allow the solenoid 44 to be activated by the glove box ECU 51. In this case, the glove box ECU 51 maintains the glove box 18 in the locked state.

The glove box ECU 51 checks the authentication ECU 7 for the authentication result of the in-vehicle authentication when the pushing of the operation button 30 starts. When the in-vehicle authentication is not established, the authentication ECU 7 provides the glove box ECU 51 through the in-vehicle LAN 11 with a signal indicating non-establishment of the in-vehicle authentication. Thus, the glove box ECU 51 maintains the solenoid 44 in a deactivated state in accordance with the in-vehicle authentication non-establishment signal even if the pushing of the operation button 30 is detected.

The solenoid 44, when deactivated, does not magnetically attract the plate 47. Thus, the operation bar 40 and the lock release bar 46 are disconnected parts. When the operation button 30 is pushed, only the operation bar 40 moves and the lock release bar 46 remains at the initial position, as shown in the state of FIG. 9. As a result, the lock release bar 46 cannot separate the lock bar 23 from the fastening hole 28. Thus, the operation of the operation button 30 becomes a null operation, and the glove box 18 remains closed and does not open. This prevents unauthorized opening of the glove box 18 under a situation in which the in-vehicle authentication is not established.

In the present example, the operation bar 40 that cooperates with the operation button 30 is arranged between the operation button 30 and the lock release bar 46. The solenoid 44 and the plate 47, which become integrally connected parts by attraction of the operation bar 40 to the lock release bar 46, are arranged between the operation bar 40 and the lock release bar 46. When the in-vehicle authentication is established, activation of the solenoid 44 is allowed thereby permitting unlocking of the glove box 18. This transmits the operation force of the operation button 30 to the lock release bar 46 and thereby allows for the glove box lid 19 to open. If the in-vehicle authentication is not established, activation of the solenoid 44 is not allowed and the glove box 18 remains in the locked state. Further, the operation force of the operation button 30 is not transmitted to the lock release bar 46. This disables opening of the glove box lid 19.

Since the operation button 30 and the lock release bar 46 (lock bar 23) are not mechanically connected to each other when the glove box 18 is in the locked state, even if the operation button 30 is pushed in the locked state, the operation force of the operation button 30 will not be transmitted to the lock bar 23, and only the operation button 30 will move (null operation). In case excessive force is applied to the operation button 30 to break the engagement of the lock bars 23 and the fastening holes 28 in an unauthorized manner, force is not transmitted to the lock bar 23. Thus, the lock cannot be broken. In this manner, the electric lock resists unauthorized unlocking.

The preferred embodiment has the advantages described below.

(1) The door latch device 22 for pushing the lock bars 23 inward with the lock release bar 46 and opening the glove box lid 19 when the operation button 30 is pushed includes the mechanism 39. The mechanism 39 locks and unlocks the glove box 18 by mechanically connecting or disconnecting the operation button 30 and the lock release bar 46 with the magnet force of the solenoid 44. Thus, even if the operation button 30 is operated when the glove box 18 is in the locked state, the operation button 30 performs a null operation. This prevents the door latch device 22 from being broken by the application of excessive force to the operation button 30. Thus, the glove box 18 does not open in an unauthorized manner, and security is improved from the viewpoint of unauthorized opening.

(2) When the in-vehicle authentication is established and the glove box 18 is in the unlocked state, power is supplied to the solenoid 44 at a timing in which the button operation detection switch 37 detects that the operation button 30 has been pushed. Then, the pushing of the operation button 30 releases the lock bar 23. Thus, power is supplied to the solenoid 44 only when the operation button 30 is pushed to open the glove box 18. This saves energy of the power supply (i.e., in-vehicle battery) for the solenoid 44.

(3) The requirement for unlocking the glove box 18 includes establishment of the in-vehicle authentication. Normally, a true user would carry an authorized electronic key. This prevents a third person who does not have the authorized electronic key from opening the glove box 18. Thus, the security of the glove box 18 is improved.

(4) The operation bar 40, which moves in cooperation with the operation button 30, is arranged between the operation button 30 and the lock release bar 46. The solenoid 44 and the plate 47 are arranged between the operation bar 40 and the lock release bar 46 to connect and disconnect the operation button 30 and the lock release bar 46. Thus, a solenoid component that has such a function does not need to be attached to the operation button 30. This simplifies the structure of the operation button 30.

It should be apparent to those skilled in the art that the present invention may be embodied in many other specific forms without departing from the spirit or scope of the invention. Particularly, it should be understood that the present invention may be embodied in the following forms.

Activation of the solenoid 44 is not limited to the timing at which the button operation detection switch 37 detects the pushing of the operation button 30. The solenoid 44 may be activated at a timing in which the authentication ECU 7 checks that the in-vehicle authentication is established.

The locking and unlocking of the glove box 18 is not limited to a mode in which the glove box ECU 51 recognizes locking or unlocking by checking the in-vehicle authentication to the authentication ECU 7. When checking whether the in-vehicle authentication is established, the authentication ECU 7 may output the authentication result to the glove box ECU 51 when the authentication determination is completed, and the glove box ECU 51 may enter any of a locking mode and an unlocking mode when the authentication determination is completed.

The lock bar 23 does not have to be arranged in the glove box lid 19, and the operation button 30 (including operation bar 40 and lock release bar 46) does not have to be arranged inn the frame 27 (i.e., glove box lid support member). The structure of each of these combinations may be reversed.

The movement direction of a bar part such as the lock bar 23 and the pushing direction of the operation button 30 are not limited to orthogonal directions. These components may be arranged to move in the same direction.

A verification unit is not limited to in-vehicle authentication and may perform, for example, vehicle exterior authentication. The verification unit is not limited to a smart authentication type (key-operation-free system 6) and may be, for example, a mechanical key authentication type for use with a mechanical key, an immobilizer authentication type that performs authentication with a transponder incorporated in the electronic key 2, or a biometric type that performs authentication using part of the human body for identification.

When using the solenoid 44 as an actuator in the mechanism 39, the solenoid 44 is not limited to a holding solenoid and other types of solenoids may be used instead. Further, the actuator of the mechanism 39 is not limited to the solenoid and other actuators such as a motor may be used instead.

A detector for detecting the pushing of the operation button 30 is not limited to a contact type detector such as the button operation detection switch 37, and a non-contact detector such as an optical sensor or a magnetic sensor may be used instead.

The solenoid 44 of the mechanism 39 does not have to be arranged on the operation bar 40, which is an individual part that moves in cooperation with the operation button 30. For example, the solenoid 44 may be incorporated in the operation button 30 and the operation bar 40 may be omitted so that the operation button 30 is directly attracted to the lock release bar 46.

The operation unit is not limited to the operation button 30, the operation type of which is a push-type, and a rotary type or a slide type may be used instead.

The conversion mechanism for converting the force in the pushing direction of the operation button to an orthogonal direction to move the operation bar 40 (lock release bar 46) is not limited to the structure formed by both of the bar slope 41 and the button slope 42 and may be formed by only either one of these slopes.

The glove box lid 19 does not have to move downward when opening as shown in FIG. 2 and may move upward instead.

The glove box lid 19 does not have to open using its own weight, and a structure in which an urging member for assisting the opening may be used to ensure easy opening.

One lock bar may be used instead of two lock bars 23.

The fastening hole 28 to which the lock bar 23 is engaged with may be a recess.

The electronic key system 3 is not limited to the key-operation-free system 6, and a wireless key system in which a button operation is performed with the key 2 for key code transmission from the electronic key 2 may be used. Alternatively, an immobilizer system employing the above-mentioned transponder may be used.

The electric lock of the present example may be adapted to various accommodation bodies other than the glove box 18.

In the electric lock according to claim 1, the operation unit, the disconnection unit, and the lock release member may be arranged on the frame side for supporting the lid in an openable manner, and the lock member may be arranged on the lid. This simplifies the structure of the lid and reduces the number of components in the lid.

The present examples and embodiments are to be considered as illustrative and not restrictive, and the invention is not to be limited to the details given herein, but may be modified within the scope and equivalence of the appended claims.

What is claimed is:

1. An electric lock for an open/close body, in which the open/close body is closed when a lock member is engaged with a fastening portion and allowed to open when the lock member is disengaged from the fastening portion, the electric lock comprising:
an operation unit operated by an operation personnel when opening the open/close body;
a verification unit which performs individual verification of the operation personnel;
a lock release member which pushes the lock member and separates the lock member from the fastening portion when the operation unit is operated in a state in which the individual verification is established;
a disconnection unit which operates in accordance with an electrical signal, with the disconnection unit arranging the operation unit and the lock release member as integrally connected parts in a state in which the individual verification is established, and the disconnection unit arranging the operation unit and the lock release member as disconnected parts in a state in which the individual verification is not established; and
a control unit which receives an individual verification result from the verification unit and drives the disconnection unit in accordance with the individual verification result;
wherein unless the individual verification is established, the control unit prohibits the disconnection unit from switching the operation unit and the lock release member to the integrally connected parts and disables opening of the open/close body.

2. The electric lock according to claim 1, further comprising:
a detector which detects operation of the operation unit;
wherein the control unit activates the disconnection unit when the detector detects operation of the operation unit in a state in which the individual verification is established; and
the disconnection unit, when activated by the control unit, arranges the operation unit and the lock release member as the integrally connected parts when activated by the control unit so as to allow the open/close body to open.

3. The electric lock according to claim 1, wherein the verification unit includes an electronic key authentication unit which performs key authentication as the individual verification by authenticating a key code transmitted through wireless communication from an electronic key with an ID code of the verification unit.

4. The electric lock according to claim 1, wherein the disconnection unit includes:
a cooperative member which moves in cooperation with the operation unit, with the cooperative member being mechanically separated from the lock release member; and
a switching member arranged between the cooperative member and the lock release member, in which the switching member operates in accordance with the control unit and switches the operation unit and the lock release member to either the integrally connected parts or the disconnected parts.
